(19) United States
(12) Patent Application Publication
(10) Pub. No.: US 2011/0079492 A1
(43) Pub. Date: Apr. 7, 2011

(54) AN APPARATUS FOR RECLAIMING ROLLING MATERIAL FROM A PILE

(75) Inventor: Pekka Kokko, Hollola (FI)

(73) Assignee: ANDRITZ OY, Helsinki (FI)

(21) Appl. No.: 12/997,336

(22) PCT Filed: Jun. 10, 2009
(86) PCT No.: PCT/FI09/50493

§ 371 Date: Dec. 10, 2010

(30) Foreign Application Priority Data
Jun. 11, 2008 (FI) 20080402

(51) Int. Cl. B65G 65/28

(52) U.S. Cl. 198/510.1

(57) ABSTRACT

The invention relates to an apparatus for reclaiming rolling material, such as e.g. wood chips, bark or corn from a pile (10) to a conveyor (20) below the storing point, which apparatus comprises a reclaimer boom (50) that is supported onto a center column (30), to which reclaimer boom (50) transporting means (55) are connected for transferring material being reclaimed to a conveyor (20) below the storing point. It is characteristic for the apparatus that the reclaimer boom (50) and/or the transporting means (55) are supported by means of at least one intermediate support (80) in addition to being supported at their ends.

The present invention relates to an apparatus for reclaiming rolling material, such as e.g. wood chips, bark, corn or fine-grained material, from a pile.

Reclaiming rolling material, such as wood chip piles, is known to use a reclaimer e.g. presented in FI-publication 98 808, wherein a rake and a screw conveyor attached on a reclaimer boom are used in reclaiming chips or other rolling material from a pile. By moving the rake, conveying the material being reclaimed to a conveyor is facilitated, which in turn conveys the material being reclaimed into the center for transportation to the next conveyor.

For example, in the field of woodhandling the volume of storages as well as chipping and discharge capacities (i-m3/h) are strongly increasing. This causes a troublesome problem in the prior art technique, because today the piles of rolling material are made bigger than earlier, width even over 80 meters, whereby the length of the reclaimer boom significantly increases.

The problem in the prior art is, that when the support distance increases, the rigidity of the boom frame must be exponentially increased. This can be obtained by using heavier beams, which in turn results in increasing own weight and further in a need to increase rigidity. Another way to increase rigidity is to increase outer dimensions of the boom frame.

Another problem in prior art solutions is caused by loads tending to circulate the boom, such as the mass of the inclined protruding rake. A known way to eliminate the torque in the frame is to balance the rake etc. with a counterweight. Because the rake is moving continuously back and forth from one end of the boom to the other, the counterweight must be mounted to move together with the rake. Thus, the mass moving on the boom i.e. dynamic load directed to the boom increases, and the bigger the storage and discharge capacity are, the bigger the moving mass increases.

The present invention provides a solution for the above problems. According to the present invention, a novel solution has been developed for supporting the reclaimer boom in an apparatus for reclaiming rolling material, such as e.g. wood chips, bark or corn, from a pile. The apparatus comprises e.g. a reclaimer boom, which is supported on one end on to center column of the reclaimer and on the other end on wheel members, and transportation means attached on the reclaimer boom for transferring the material being reclaimed to a conveyor located below the storing point. The above mentioned problems of the reclaimers used at present are solved according to the present invention by supporting the reclaimer boom in addition to its ends at least by one intermediate support, preferably with a wheel.

In accordance with the invention, the effect of loads twisting the boom is eliminated with the intermediate support of the reclaimer boom. In locating the intermediate support in relation to cross section of the frame optimally so, that it would solve the torque problem, the problem is space utilization below the boom. A conveyor screw requires its own space and the support wheels must be mounted on the backside of the screw. We have solved the torque problem by supporting the reclaimer boom with intermediate supports, preferably with wheels, by choosing the location of the support wheels in relation to the cross section of the boom and by attaching a solid counterweight into frame at the supporting wheels in the longitudinal direction of the frame. The boom may have one or more intermediate supports. A container with electrical equipment connected to the reclaimer and if needed other additional mass, such as steel or concrete weights, are used as a counterweight. The intermediate support is preferably fastened to reclaimer boom or to transportation means essentially to the middle point of the reclaimer boom, or there can be several intermediate supports and they can be located with suitable spacing to the reclaimer boom.

According to another preferred embodiment of the invention, we have developed a solution for the support wheel frames, with which we can adjust the portion of the vertical loads individually to each wheel. This is done by adjusting the height of the wheel frame and by measuring simultaneously the vertical load to be carried by the wheel. Adjustment is carried out by means of a hydraulic cylinder, whereby the force can be calculated according to measures of the cylinder and pressure of the pump. A wheel construction includes an adjustment rod, blocking of which is released when the adjustment by means of the hydraulic cylinder is started. After releasing the blocking, it is possible to change the height of the wheel support frame steplessly. After the desired load has been reached, the adjusting rod is locked again and the hydraulic cylinder is removed.

The intermediate support of the reclaimer boom is preferably at least one wheel, preferably a pair of wheels. According to a preferred embodiment of the invention, a support of the reclaimer boom, preferably a wheel or a pair of wheels, is a drive wheel. Using such a drive wheel or a pair of drive wheels in supporting the boom, reduces the lateral load coming to the center column of the reclaimer. In accordance with the invention, a plow being arranged on the reclaimer boom in front of an intermediate support or a pair of intermediate supports assists using at least one intermediate support in supporting the boom, which plow moves a mat of remained rolling material, such as wood chips, to the storing point out of the way of the support or supports. This ensures the disturbance-free/free movement of the support, and thus e.g. bends of the reclaimer boom are avoided, which could occur when the support would for even a moment get stuck during a free movement of the wheel mounted on the other end of the boom or when a single support climbs on a chip mat.

Further, according to the invention the support used in supporting the boom, preferably a wheel or a pair of wheels, is adjustable in the vertical direction. By means of the vertical adjustment, a precisely desired load to a wheel or to a pair of wheels can be obtained. In addition, by means of the adjustment also the manufacturing defects of the reclaimer boom lattice structure can be taken into account, which always necessarily exist in such big structures. Further, a wheel or a pair of wheels can be also turnable in the direction of the tangent of the pile, whereby a wheel or a pair of wheels can be placed exactly in the direction of the circumference of the pile. An advantage of this is that the axial force generated in the wheel remains insignificant during the wheels are travelling on a circular orbit.

Additionally, a wheel or a pair of wheels used as a support can be sprung, whereby it can even better receive exactly the load needed for each case from the boom. The load of the boom varies continuously during the function of the reclaimer. A rake, mounted on a trolley moving on its rails on the boom, moves back and forth over the whole length of the boom all the time. This kind of a rake weighs approximately as much as a locomotive. When the load of the rake moves on the boom, the load being transferred from the boom to the wheels changes according to the location of the rake. By means of the springing of the intermediate support, variations of the load can be deadened and the rigidity of the boom frame can be utilized more efficiently.

Additional advantages of the invention include the following:
the boom can be designed to have a significantly lighter construction and with smaller cross sectional dimensions,
the torsional rigidity of the boom can be reduced,
the vertical forces focusing on an orbit or orbits via the wheels are distributed on a larger area and
the changing of the wheel can be performed simply by lightening the load of said wheel off, whereby the whole boom does not need to be jacked up.

In the following, the invention is disclosed in more detail with reference to the appended figures, of which

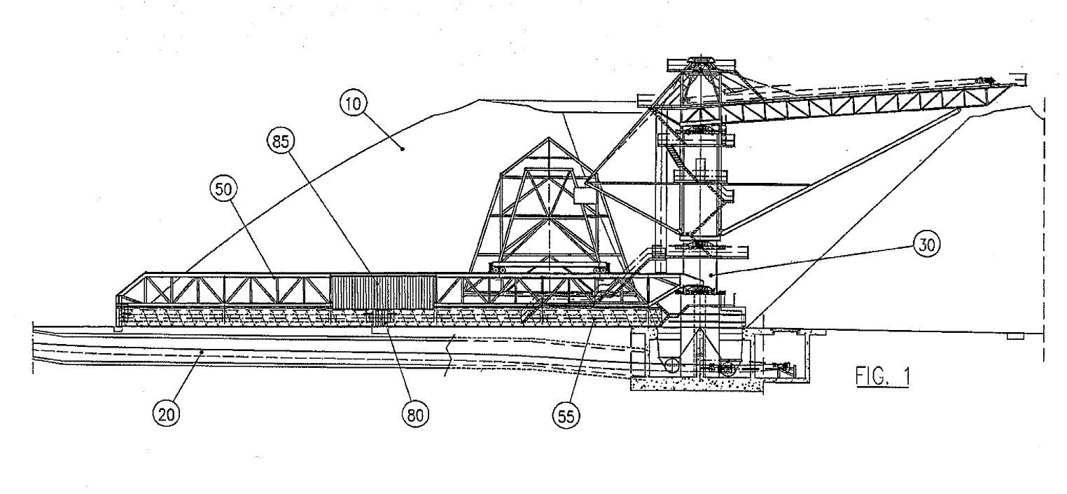

FIG. 1 illustrates a reclaimer according to the invention,

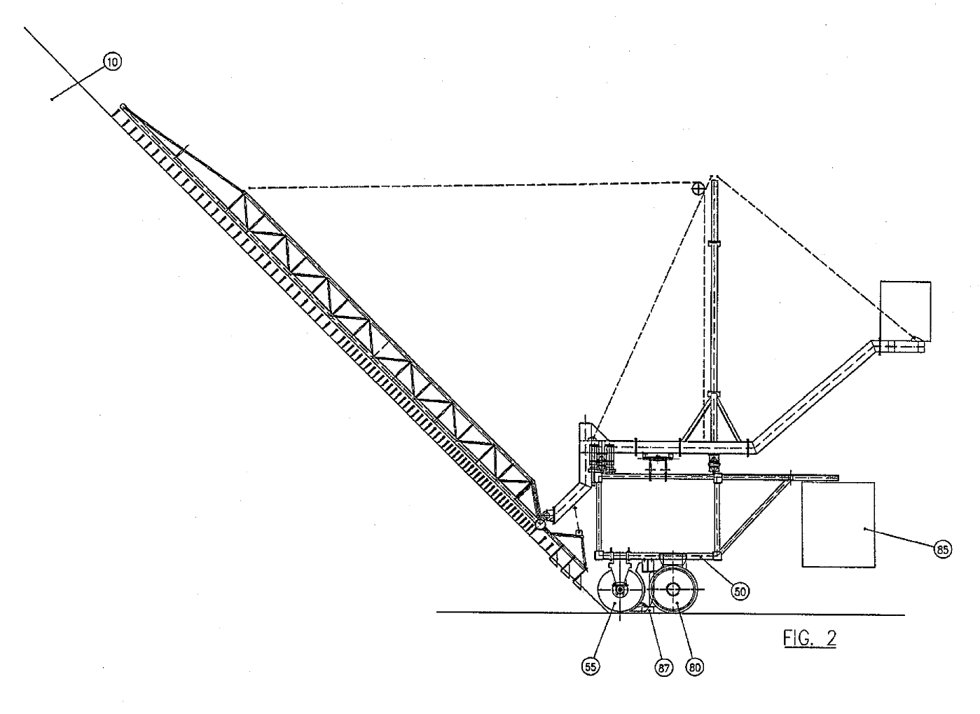

FIG. 2 illustrates a reclaimer according to a preferred embodiment of the invention, and

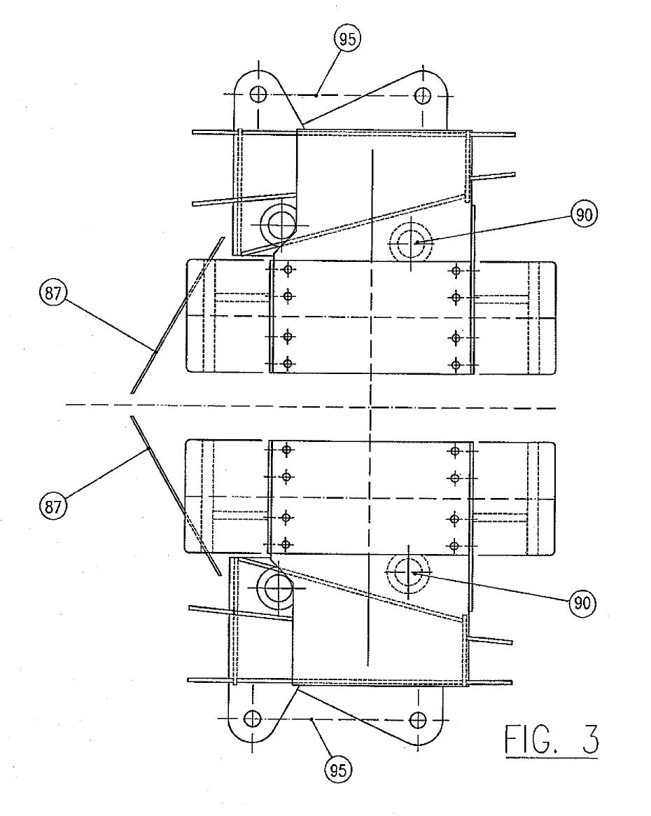

FIG. 3 illustrates a detail of an intermediate support of a reclaimer according to the invention.

FIG. 1 illustrates a solution according to a preferred embodiment of the invention, with an apparatus for reclaiming rolling material, such as e.g. wood chips, bark or corn, from a pile 10 to a conveyor 20 below the storing point. The reclaimer comprises a reclaimer boom 50, which is supported on its one end on the center column 30 and on its other end on wheel members. Transporting means 55 are connected on the reclaimer boom 50 for transferring the material being reclaimed to the conveyor 20 below the storing point. The reclaimer boom 50 and/or the transporting means 55 are supported in addition to their ends at least by one intermediate support 80. In accordance with an embodiment of the invention illustrated in the figure, the intermediate support 80 is arranged essentially to the middle point of the reclaimer boom 50, but the intermediate support 80 or intermediate supports 80 can be located with also otherwise preferable spacing on the boom 50.

According to a preferred embodiment of the invention, a container with electrical equipment 85 (FIG. 2) is arranged for a counterweight on the reclaimer boom 50 at the intermediate support 80. Using a container with electrical equipment to balance the forces tending to twist the boom assists also in power supply to moving parts of the reclaimer when the container with electrical equipment is moving along the boom. Thus, the need for electric cables coming from the ground to the moving parts can be minimized. If needed, also or only additional weights, such as steel or concrete weights, can be arranged at the intermediate support 80. Further, FIG. 2 illustrates a plow 87 arranged on the reclaimer boom 50 in front of an intermediate support 80 according to the invention, which assists using of the intermediate support 80 in accordance with the invention.

FIG. 3 illustrates a pair of support wheels in accordance with the invention in more detail from above. Wheels can be adjusted by means of a hydraulic cylinder i.e. a jack 90 in the vertical direction and in addition, they can be turned by means of an adjustment rod 95 sideward to the direction of the tangent.

Although the above description relates to an embodiment of the invention that is in the light of present knowledge considered the most preferable, it is obvious to a person skilled in the art that the invention can be modified in many different ways within the broadest possible scope defined by the appended claims alone.

1. (canceled)

2. An apparatus according to claim 12, wherein the intermediate support device is at a middle point of the reclaimer boom.

3. An apparatus according to 12 wherein the intermediate support device includes at least one wheel.

4. An apparatus according to claim 3, wherein the intermediate support device includes a pair of wheels.

5. An apparatus according to claim 12, wherein a height of the intermediate support device is adjustable in a vertical direction.

6. An apparatus according to claim 5, wherein the intermediate support device includes a hydraulic cylinder which provides the vertical adjustment of the intermediate support device.

7. An apparatus according to claim 12, wherein the intermediate support device rotates about a direction tangent of an edge of the pile adjacent the reclaimer boom.

8. An apparatus according to claim 7, wherein the intermediate support device includes an adjustment rod for tangential adjustment of the intermediate support device.

9. An apparatus according to claim 12, further comprising a weighted container arranged on the reclaimer boom proximate to the intermediate support device, wherein the weighted container counteracts a torque applied to the reclaimer boom.

10. An apparatus according to claim 12, further comprising a plow is arranged on the reclaimer boom in front of the intermediate support device.

11. An apparatus according to claim 12, characterized in that the support of the wheel is sprung.

12. An apparatus for transferring a rolling material from a pile on a storing surface to a conveyor below the storing surface, the apparatus comprises:
a reclaimer boom supported at one end region by a center column and at an opposite end region by an end support device which engages the storing surface;
a material transport device extending along at least a portion of the reclaimer boom, the transport device configured to move the rolling material from the pile to the conveyor, and
an intermediate support device coupled to at least one of the reclaimer boom and the material transport device, wherein the intermediate support device provides a structural support to the reclaimer boom, engages the storing surface and the intermediate support device includes a driving mechanism to propel the intermediate support device over the storing surface.

13. A reclaimer apparatus to transfer granular material from a pile on a storing surface to a first conveyor below the storing surface, the apparatus comprises:
a reclaimer boom supported at one end region by a center column and at an opposite end region by an end support device having at least one wheel engaging the storing surface, wherein the reclaimer boom extends along the pile and is above the storing surface;
a second conveyor extending along at least a portion of the reclaimer boom, the transport device configured to move the granular material from the pile to the first conveyor, and
an intermediate support device coupled to at least one of the reclaimer boom and the second conveyor, wherein the intermediate support device provides structural support to a middle region of the reclaimer boom and the intermediate support device, includes at least one wheel engaging the storing surface, wherein the at least one wheel is driven to propel the support device over the storing surface.

14. The reclaimer apparatus of claim 13 wherein the intermediate support device includes an elevation mechanism to adjust a height of the support device and thereby adjust a loading force applied by reclaimer beam to between the at least one wheel and the storing surface.

15. The reclaimer apparatus of claim 13 further including a counterbalance attached to the reclaimer boom or the second conveyor, wherein the counterbalance extends from a side of the reclaimer boom opposite to the pile.
